(19) United States
(12) Patent Application Publication
(10) Pub. No.: US 2025/0079875 A1
(43) Pub. Date: Mar. 6, 2025

(54) CHARGING AND DISCHARGING APPARATUS FOR VEHICLE AND CONTROL METHOD THEREOF

(71) Applicants: Hyundai Motor Company, Seoul (KR); Kia Corporation, Seoul (KR)

(72) Inventor: Min Seong Choi, Hwaseong-si (KR)

(21) Appl. No.: 18/604,882

(22) Filed: Mar. 14, 2024

(30) Foreign Application Priority Data
Sep. 4, 2023 (KR) 10-2023-0117084

(51) Int. Cl. H02J 7/04; H02M 1/00; H02M 1/42

(52) U.S. Cl. CPC H02J 7/04; H02M 1/0064; H02M 1/4216

(57) ABSTRACT

A charging and discharging apparatus for a vehicle and a control method thereof are disclosed. In an embodiment, the charging and discharging apparatus can include a charging/discharging port, a power factor correction circuit, an input filter unit, a surge protection circuit unit, and a controller configured to sequentially turn off second and third switches of the input filter unit in response to charging through first to third AC terminals of the charging/discharging port being ended.

### CROSS-REFERENCE TO RELATED APPLICATIONS

This application claims the benefit of Korean Patent Application No. 10-2023-0117084, filed on Sep. 4, 2023, which application is hereby incorporated herein by reference.

### TECHNICAL FIELD

The present disclosure relates to a charging and discharging apparatus for a vehicle.

### BACKGROUND

Recently, in accordance with a global tendency toward a reduction in carbon dioxide emissions, demand for an electrified vehicle configured to generate driving power by driving a motor using electrical energy stored in an energy storage device such as a battery, in place of a typical internal combustion engine vehicle configured to generate driving power through combustion of fossil fuels, has greatly increased.

Such an electrified vehicle may include an on-board charger (OBC) configured to recharge a battery using system power. Generally, such an on-board charger (OBC) is constituted by a power factor correction circuit (PFC) configured to convert an external AC voltage into a DC voltage, and a DC/DC converter configured to adjust the converted DC voltage into a voltage required for a battery.

When a relay at the side of an input circuit of a charger is turned off simultaneously with ending of charging of the electrified vehicle as mentioned above, an overvoltage may be instantaneously generated in the charger. In this case, a current path to the ground may be formed for surge protection.

Meanwhile, when a current path to the ground is formed, current may leak along the current path to the ground. Therefore, a scheme for reducing leakage of current should be proposed.

The above matters disclosed in this section are merely for enhancement of understanding of the general background of the disclosure and should not be taken as an acknowledgement or any form of suggestion that the matters form the related art already publicly known.

### SUMMARY

The present disclosure relates to a charging and discharging apparatus for a vehicle configured to reduce generation of leakage current, and a control method thereof.

An embodiment of the present disclosure provides a charging and discharging apparatus for a vehicle capable of reducing generation of current leakage through a current path to the ground by adjusting turn-off time points of switches provided at the side of an input circuit when charging of the vehicle, for example, an electrified vehicle, is ended, and a control method thereof.

It can be appreciated by persons skilled in the art to which the present disclosure pertains that technical problems to be solved by the present disclosure are not necessarily limited to the above-described technical problems.

In accordance with an embodiment of the present disclosure, a charging and discharging apparatus for a vehicle includes a charging/discharging port including a first AC terminal, a second AC terminal, a third AC terminal, and a neutral terminal. The charging/discharging port can be configured to transmit external power to a battery connected thereto or to transmit power of the battery to an exterior thereof. An embodiment can include a power factor correction circuit including a plurality of inductors respectively corresponding to the first AC terminal, the second AC terminal, and the third AC terminal, an input filter unit including a first switch configured to selectively interconnect the first AC terminal and a corresponding one of the inductors, a second switch configured to selectively interconnect the second AC terminal and a corresponding one of the inductors, and a third switch configured to selectively interconnect the third AC terminal and a corresponding one of the inductors, a surge protection circuit unit connected between the first to third AC terminals and a ground, and connected to form a current path to the ground when a surge is generated at least one of the first AC terminal, the second AC terminal, or the third AC terminal, and a controller configured to sequentially turn off the second switch and the third switch when charging through the first to third AC terminals is ended.

The input filter unit may further include an interleaving switch configured to selectively interconnect the first AC terminal and the second AC terminal.

The controller may turn on the interleaving switch after turning off the second switch, and may then turn off the third switch after turning-off the interleaving switch.

The controller may turn off the interleaving switch after turning-off the third switch.

The controller may perform turning-off of the second switch, turning-on of the interleaving switch, turning-off of the third switch, and turning-off of the interleaving switch at intervals of a predetermined time.

The predetermined time interval may be set taking into consideration one of or both of a time taken to turn on at least one of the second switch, the interleaving switch, or the third switch, or a time taken to turn off at least one of the second switch, the interleaving switch, or the third switch.

The controller may turn off the first switch when the charging is ended.

The surge protection circuit unit may include a plurality of varistors each connected between corresponding ones of the first to third AC terminals and the inductors, and an arrester configured to transmit current to the ground when a voltage equal to or higher than a predetermined value is applied.

The first switch may be connected to a pre-charge resistor in parallel.

The controller may turn on the first switch, the second switch, and the third switch upon performing charging through the first AC terminal, the second AC terminal, and the third AC terminal.

In accordance with an embodiment of the present disclosure, a method for controlling the charging and discharging apparatus includes sequentially turning off the second switch and the third switch by the controller when charging through the first AC terminal, the second AC terminal, and the third AC terminal is ended.

The sequentially turning off may include turning off the second switch and then turning off the third switch by the controller when the first AC terminal and the second AC terminal are selectively interconnected through an interleaving switch.

The turning off of the second switch and then turning off the third switch by the controller may include turning on the interleaving switch by the controller after turning-off the second switch and turning off the third switch by the controller after turning-on of the interleaving switch.

The method may further include turning off the interleaving switch by the controller after turning-off the third switch.

The turning-off of the second switch, the turning-on of the interleaving switch, the turning-off of the third switch, and the turning-off of the interleaving switch may be performed at intervals of a predetermined time. The predetermined time interval may be set by taking into consideration one of or both of a time taken to turn on at least one of the second switch, the interleaving switch, or the third switch or a time taken to turn off at least one of the second switch, the interleaving switch, or the third switch.

The method may further include turning off the first switch by the controller when the charging is ended.

The method may further include turning on the first switch, the second switch, and the third switch by the controller upon performing charging through the first AC terminal, the second AC terminal, and the third AC terminal.

In accordance with an embodiment of the present disclosure, it may be possible to reduce generation of current leakage to the ground and to alleviate operation of an earth leakage circuit breaker at the side of an external charger when charging of the electrified vehicle is ended.

The advantages of the embodiments of the present disclosure are not necessarily limited to the above-described advantages and other advantages not described herein may be derived by those skilled in the art from the present description.

### BRIEF DESCRIPTION OF THE DRAWINGS

The above and other features and other advantages of the present disclosure can be more clearly understood from the following detailed description taken in conjunction with the accompanying drawings, in which:

FIG. 1 is a circuit diagram of a charging and discharging apparatus for a vehicle according to an embodiment of the present disclosure;

FIG. 2 is a diagram explaining a control procedure of the charging and discharging apparatus according to an embodiment of the present disclosure; and

FIG. 3 is a flowchart explaining a control method of the charging and discharging apparatus according to an embodiment of the present disclosure.

### DETAILED DESCRIPTION OF ILLUSTRATIVE EMBODIMENTS

For embodiments of the present disclosure disclosed herein, specific structural or functional descriptions are examples to merely describe the embodiments of the present disclosure, and embodiments of the present disclosure can be implemented in various forms and should not be interpreted as being necessarily limited to the embodiments described in the present specification.

The specific example embodiments should not be construed as necessarily limiting the potential embodiments of the present disclosure, but should be construed as extending to all modifications, equivalents, and substitutes included in the technological scope of the disclosure.

Unless defined otherwise, terms used herein, including technological or scientific terms, can have the same meaning as generally understood by those of ordinary skill in the art to which the disclosure pertains. The terms used herein can be interpreted not only based on the definition of any dictionary but also the meaning that is used in the field to which the disclosure pertains.

Hereinafter, embodiments of the present disclosure will be described in detail with reference to the accompanying drawings, and the same or similar elements can be designated by the same reference numerals regardless of the numerals in the drawings and redundant description thereof can be omitted.

In the following description of embodiments, the term “predetermined” can be a parameter used in a process or an algorithm, the numerical value of the parameter has been previously determined. The numerical value of the parameter may be set when the process or the algorithm is begun or during a period in which the process or algorithm is executed in accordance with an embodiment.

The suffixes “module” and “unit” of elements herein can be used for convenience of description and thus can be used interchangeably.

In the following description of the embodiments of the present disclosure, a detailed description of known functions and configurations incorporated herein can be omitted when it may obscure the subject matter of the embodiments of the present disclosure. In addition, embodiments of the present disclosure can be more clearly understood from the accompanying drawings and should not necessarily be limited by the accompanying drawings, and it can be appreciated that all changes, equivalents, and substitutes that do not depart from the spirit and technical scope of the present disclosure are encompassed in the present disclosure.

It will be understood that, although the terms “first,” “second,” etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions can include a plural meaning.

In this specification, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

In addition, the term “unit” or “control unit” used in specific terminology such as a motor control unit (MCU), a hybrid control unit (HCU) or the like is only a term widely used for designation of a controller for controlling a particular function of a vehicle and, as such, does not mean a generic functional unit.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

A charging and discharging apparatus for a vehicle according to an example embodiment of the present disclosure and a control method thereof propose that, when charging of an electrified vehicle, in particular, charging of the electrified vehicle using three-phase power, is ended, a plurality of switches provided at a circuit disposed at the side of an input for, in particular, three-phase power be sequentially turned off, to reduce current leakage caused by generation of a surge when charging is ended.

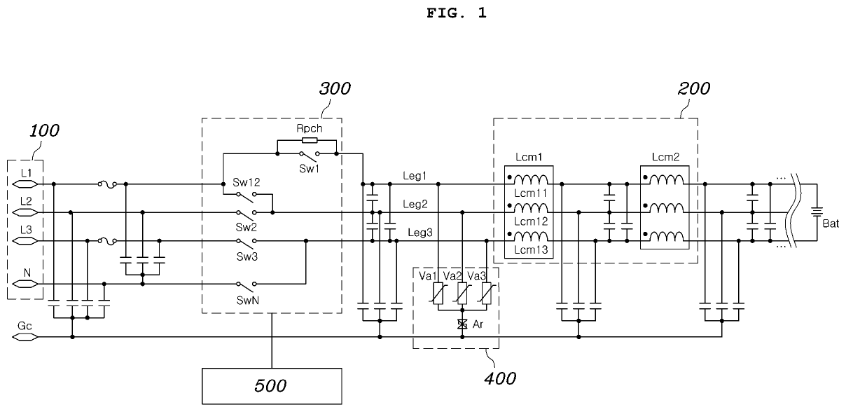

FIG. 1 is a circuit diagram of a charging and discharging apparatus for a vehicle according to an embodiment of the present disclosure.

Referring to FIG. 1, a charging and discharging apparatus according to an embodiment of the present disclosure may include a charging/discharging port 100, a power factor correction circuit 200, an input filter unit 300, a surge protection circuit unit 400, and a controller 500. FIG. 1 mainly shows constituent elements associated with an embodiment of the present disclosure, but the charging and discharging apparatus may be practically implemented through inclusion of a greater or smaller number of constituent elements than that of the shown constituent elements.

The charging/discharging port 100 may include a first AC terminal L1, a second AC terminal L2, a third AC terminal L3, and a neutral terminal N. The charging/discharging port 100 may receive external power through the first to third AC terminals L1 to L3, and may then transmit the received power to a battery BAT connected thereto or may transmit power of the battery BAT to an exterior thereof.

The power factor correction circuit 200 may include a plurality of inductors Lcm1 respectively corresponding to the first AC terminal L1, the second AC terminal L2, and the third AC terminal L3, and may additionally include a plurality of inductors Lcm2.

The input filter unit 300 may include a first switch Sw1 configured to selectively interconnect the first AC terminal L1 and a corresponding one of the inductors Lcm1, that is, an inductor Lcm11, a second switch Sw2 configured to selectively interconnect the second AC terminal L2 and a corresponding one of the inductors Lcm1, that is, an inductor Lcm12, and a third switch Sw3 configured to selectively interconnect the third AC terminal L3 and a corresponding one of the inductors Lcm1, that is, an inductor Lcm13. The first switch Sw1, the second switch Sw2, and the third switch Sw3 may be embodied as, for example, relays, without being necessarily limited thereto. For the first to third switches Sw1 to Sw3, any elements may be applied that can interconnect respective AC terminals L1 to L3 and respective inductors Lcm1.

The surge protection circuit unit 400 may be connected between the first to third AC terminals L1 to L3 and a ground Gc, and may form a current path to the ground Gc when a surge is generated at one or more of the first to third AC terminals L1 to L3.

In more detail, the surge protection circuit unit 400 may be configured through inclusion of a plurality of varistors Va1, Va2, and Va3, each connected between corresponding ones of the first to third AC terminals L1 to L3 and the inductors Lcm11, Lcm12, and Lcm13, respectively, and an arrester configured to transmit current to the ground Gc when a voltage equal to or higher than a preset, predetermined, or selected value is applied.

Each of the plurality of varistors Va1, Va2, and Va3 can have a variable resistance such that the resistance thereof is reduced when a voltage applied thereto increases and, as such, may induce a flow of current to the side of the surge protection circuit unit 400 when a high voltage is generated. The arrester Ar may form a current path to the ground Gc when a surge is generated, thereby protecting the charging and discharging apparatus from the surge.

The controller 500 may control switching, that is, turning-on and turning-off of the first to third switches Sw1 to Sw3. In particular, the controller 500 may sequentially turn off the second switch Sw2 and the third switch Sw3 when charging through the first to third AC terminals L1 to L3 is ended.

In other words, the controller 500 may turn off at least the second switch Sw2 and the third switch Sw3 to end charging using three-phase power applied through the first AC terminal L1, the second AC terminal L2, and the third AC terminal L3. Sequential turning-off of the second switch Sw2 and the third switch Sw3 may be performed, in place of simultaneous turning-off of the second switch Sw2 and the third switch Sw3.

When the second switch Sw2 and the third switch Sw3 are simultaneously turned off, a surge may be generated between the first AC terminal L1 and the inductor Lcm11 corresponding thereto in accordance with the magnitude and the phase of an AC voltage at the turn-off time. The surge protection circuit 400 may operate for surge protection. The surge protection circuit unit 400 may form a current path between the first AC terminal L1 and the ground Gc when a surge is generated. As current flows along the formed current path, current leakage may occur. However, when the controller 500 sequentially turns off the second switch Sw2 and the third switch Sw3, as in an embodiment of the present disclosure, generation of leakage current caused by surge generation may be reduced.

In more detail, the input filter unit 300 may further include an interleaving switch Sw12 configured to selectively interconnect the first AC terminal L1 and the second AC terminal L2. The controller 500 may turn off the third switch Sw3 after turning off the second switch Sw2.

In particular, the controller 500 may turn on the interleaving switch Sw12 after turning off the second switch Sw2, and may then turn off the third switch Sw3 after turning-off of the interleaving switch Sw12.

When the interleaving switch Sw12 is turned on, a voltage may be applied not only to a first leg Leg1 between the first AC terminal L1 and the inductor Lcm11 corresponding thereto, but also to a second leg Leg2 between the second AC terminal L2 and the inductor Lcm12 corresponding thereto.

Accordingly, when the third switch Sw3 is in a turn-on state under the condition that the interleaving switch Sw12 is in a turn-on state, a voltage may be applied to even a third leg Leg3 between the third AC terminal L3 and the inductor Lcm13 corresponding thereto. Accordingly, voltages may be applied to all of the first to third legs Leg1 to Leg3 of three phases, respectively.

Meanwhile, the voltage transmitted to the arrester Ar of the surge protection circuit unit 400 can correspond to an average of voltages respectively applied to the first to third legs Leg1 to Leg3. Accordingly, the voltage transmitted to the arrester Ar can be reduced when the number of legs, to which voltages are applied, respectively, increases. In such case, it may be possible to reduce leakage of current to the ground in accordance with operation of the arrester Ar.

Thereafter, the controller 500 may turn off the third switch Sw3 and, as such, may end charging of the vehicle in a state in which the voltage transmitted to the arrester Ar is reduced. When charging is ended in accordance with turning-off of the third switch Sw3, the interleaving switch Sw12 may be turned off because application of a voltage to the second leg Leg2 is no longer used or required.

In such case, the controller 500 may perform turning-off of the second switch Sw2, turning-on of the interleaving switch Sw12, turning-off of the third switch Sw3, and turning-off of the interleaving switch Sw12 at intervals of a preset, predetermined, or selected time.

In more detail, the preset, predetermined, or selected time interval may be set taking into consideration at least one of a time taken to turn on at least one of the second switch Sw2, the interleaving switch Sw12, or the third switch sw3, or a time taken to turn off at least one of the second switch Sw2, the interleaving switch Sw12, or the third switch sw3.

For example, when the second switch Sw2, the interleaving switch Sw12, and the third switch sw3 are embodied as the same relays, the predetermined time interval may be determined by a longer one of an operation time taken from a time when a coil voltage is applied to the relay associated with the coil voltage to a time when contact of the relay is completed and a release time taken from the time when application of the coil voltage is cut off to a time when release of the contact of the relay is completed.

Meanwhile, the controller 500 may turn off the first switch Sw1 as well as the second switch Sw2 and the third switch Sw3 upon ending charging. In particular, a pre-charge resistor Rpch may be connected to the first switch Sw1 in parallel. A voltage may be applied to the first leg Leg1, irrespective of whether the first switch Sw1 is turned on or off. A pre-charging function through the pre-charge resistor Rpch may be performed when or only when the first switch Sw1 is turned off.

The charging and discharging apparatus according to the embodiment of the present disclosure may reduce transmission of an overvoltage to the surge protection circuit unit 400 by preventing occurrence of a situation in which a voltage is applied to only the first leg Leg1 when charging is ended, through control of switching of the second switch Sw2, the third switch Sw3, and the interleaving switch Sw12, as described above.

Meanwhile, the controller 500 may turn on the first switch Sw1, the second switch Sw2, and the third switch Sw3 while turning off the interleaving switch Sw12 and a neutral switch SwN connected to the neutral terminal N upon performing charging using three-phase power, such as charging through the first AC terminal L1, the second AC terminal L2, and the third AC terminal L3. Control of switching of the second switch Sw2 and the third switch Sw3 upon ending of charging may be performed under the above-described conditions.

A charging and discharging apparatus according to an embodiment of the present disclosure may perform charging using single-phase power as well as charging using three-phase power. In such case, the single-phase power may be input through the first AC terminal L1.

Upon performing charging using single-phase power, the controller 500 may turn on the first switch Sw1, the interleaving switch Sw12, and the neutral switch SwN connected to the neutral terminal N while turning off the second switch Sw2 and the third switch Sw3.

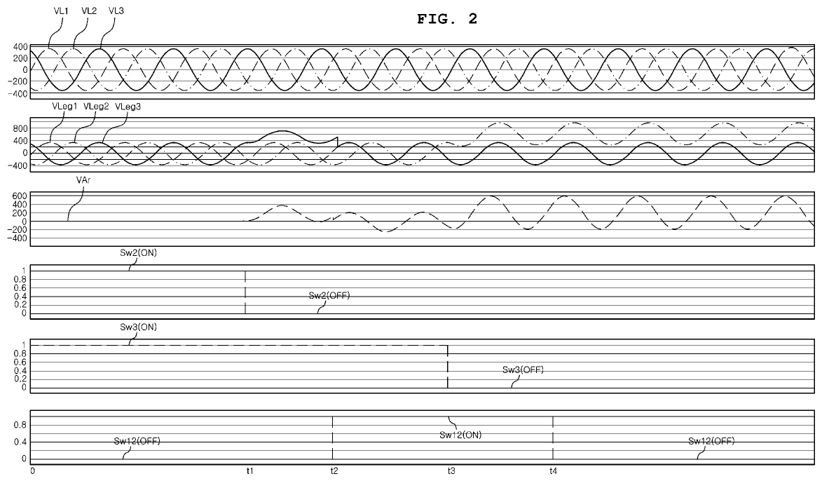

FIG. 2 is a diagram explaining a control procedure of the charging and discharging apparatus according to an embodiment of the present disclosure.

FIG. 2 illustrates phase voltages VL1, VL2, and VL3 of respective AC terminals, voltages applied to respective legs Leg1, Leg2, and Leg3, a voltage VAr applied to the arrester Ar, and switching states of the second switch Sw2, the third switch Sw3, and the interleaving switch Sw12 in a charging ending procedure according to an embodiment of the present disclosure. The voltage VAr applied to the arrester Ar may be expressed by an average of the voltages applied to respective legs Leg1, Leg2, and Leg3.

The controller 500 may perform control of charging using three-phase power until a time t1 by turning on the first switch Sw1, the second switch Sw2, and the third switch Sw3 while turning off the interleaving switch Sw12 and the neutral switch SwN.

When a charging ending sequence for ending charging using three-phase power is subsequently generated, the controller 500 may end pulse width modulation (PWM) control for a charger, and may then preferentially turn off the second switch Sw2 in order to end charging. In such case, the controller 500 may turn off the first switch Sw1 together with the second switch Sw2, but may defer turning-off of the third switch Sw3. In such state, voltages may be applied to the first leg Leg1 and the third leg Leg3, respectively, and the second leg Leg2 may be in a state with no voltage applied thereto, in accordance with turning-off thereof.

At a time t2 when a preset, predetermined, or selected time interval elapses from the time t1 when the second switch Sw2 is turned off, the controller 500 may turn on the interleaving switch Sw12, thereby enabling application of a voltage to the second leg Leg2 even in the turn-off state of the second switch Sw2. A voltage input from the first AC terminal L1 may be applied to the second leg Leg2 via the interleaving switch Sw12. In such state, voltages may be applied to all of the first leg Leg1, the second leg Leg2, and the third leg Leg3 and, as such, a voltage transmitted to the arrester Ar may be reduced. As the voltage transmitted to the arrester Ar is reduced, generation of current leakage to the ground through the arrester Ar may be reduced. Accordingly, operation of an external charger connected to the charging and discharging apparatus, such as an earth leakage circuit breaker, may be alleviated.

At a time t3 when a preset, predetermined, or selected time internal elapses from the time t2, the third switch Sw3 may be turned off under a condition that the voltage transmitted to the arrester Ar has been reduced. At a time t4 when a preset, predetermined, or selected time interval elapses from the time t3, the interleaving switch Sw2 may be turned off because a turn-on state of the interleaving switch Sw2 is no longer used or required.

In the overall procedure, the voltage VAr applied to the arrester Ar may be maintained at a maximum of less than 600V. For example, when a voltage of 600V or more is required for transmission of current to the ground through operation of the arrester Ar, the arrester Ar may not operate in a charging ending procedure and, as such, generation of current leakage to the ground may be prevented.

The overall procedure may be represented as follows.

TABLE 1

| | Sw1 | Sw2 | Sw3 | Sw12 | SwN |
|---|---|---|---|---|---|
| Three-Phase Charging | ON | ON | ON | OFF | OFF |
| Generation of Charging | ON | ON | ON | OFF | OFF |
| Ending Sequence | | | | | |
| PWM OFF | ON | ON | ON | OFF | OFF |
| First Sequence (t1~t2) | OFF | OFF | ON | OFF | OFF |
| Second Sequence (t2~t3) | OFF | OFF | ON | ON | OFF |
| Third Sequence (t3~t4) | OFF | OFF | OFF | ON | OFF |
| Fourth Sequence (t4~) | OFF | OFF | OFF | OFF | OFF |

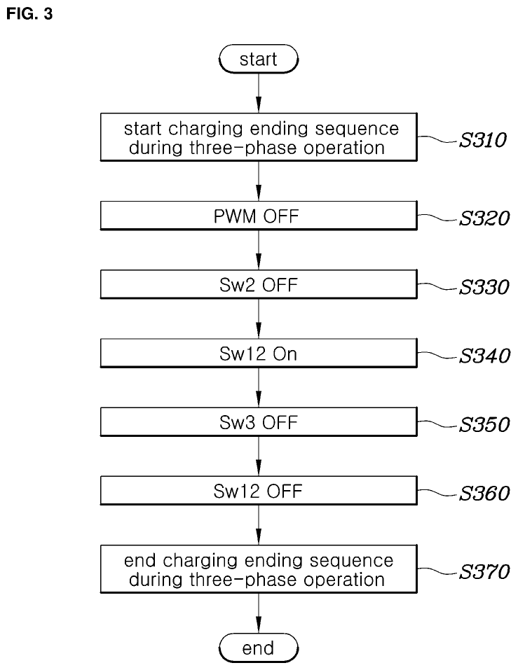

FIG. 3 is a flowchart explaining a control method of a charging and discharging apparatus according to an embodiment of the present disclosure.

Referring to FIG. 3, when a charging ending sequence is generated during charging using three-phase power (operation S310), the controller 500 may end pulse width modulation control for the charging and discharging apparatus (operation S320), and the controller 500 may then turn off the second switch Sw2 (operation S330).

When a predetermined or selected time interval then elapses, the controller 500 may then turn on the interleaving switch Sw12 before turning off the third switch Sw3 (operation S340), and may turn off the third switch Sw3 after a predetermined or selected time interval elapses from the time when the interleaving switch Sw12 is turned on (operation S350).

When a predetermined or selected time interval then elapses, the controller 500 may turn off the interleaving switch Sw12 (operation S360) such that all switches are in a turn-off state and, as such, the charging ending sequence may be completed (operation S370).

In accordance with various embodiments of the present disclosure as described above, it may be possible to reduce generation of current leakage to the ground and to alleviate operation of an earth leakage circuit breaker at the side of an external charger when charging of an electrified vehicle is ended.

Although example embodiments of the present disclosure have been disclosed for illustrative purposes, those skilled in the art can appreciate that various modifications, additions, and substitutions are possible, without departing from the scope and spirit of the disclosure as disclosed in the accompanying claims.

What is claimed is:

1. A charging and discharging apparatus for a vehicle, the apparatus comprising:
a charging/discharging port comprising a first AC terminal, a second AC terminal, a third AC terminal, and a neutral terminal, the charging/discharging port being configured to transmit external power to a battery or to transmit power of the battery to an exterior of the charging/discharging port;
a power factor correction circuit comprising a plurality of inductors respectively corresponding to the first AC terminal, the second AC terminal, and the third AC terminal;
an input filter unit comprising a first switch configured to selectively interconnect the first AC terminal and a first corresponding one of the inductors, a second switch configured to selectively interconnect the second AC terminal and a second corresponding one of the inductors, and a third switch configured to selectively interconnect the third AC terminal and a third corresponding one of the inductors;
a surge protection circuit unit connected between the first to third AC terminals and a ground, and connected to form a current path to the ground in response to a surge being generated at one or more of the first AC terminal, the second AC terminal, or the third AC terminal; and
a controller configured to sequentially turn off the second switch and the third switch in response to charging through the first to third AC terminals being ended.

2. The apparatus of claim 1, wherein the input filter unit further comprises an interleaving switch configured to selectively interconnect the first AC terminal and the second AC terminal.

3. The apparatus of claim 2, wherein the controller is configured to turn on the interleaving switch after turning off the second switch, and then turn off the third switch after turning-off the interleaving switch.

4. The apparatus of claim 3, wherein the controller is configured to turn off the interleaving switch after turning-off the third switch.

5. The apparatus of claim 4, wherein the controller is configured to perform turning-off the second switch, turning-on the interleaving switch, turning-off the third switch, and turning-off the interleaving switch at selected time intervals.

6. The apparatus of claim 5, wherein the selected time intervals depend on one of or any combination of a time taken to turn on one or more of the second switch, the interleaving switch, or the third switch, and a time taken to turn off one or more of the second switch, the interleaving switch, or the third switch.

7. The apparatus of claim 1, wherein the controller is configured to turn off the first switch when the charging is ended.

8. The apparatus of claim 1, wherein the surge protection circuit unit comprises:
a plurality of varistors, each varistor being connected between the first to third AC terminals and the corresponding ones of the inductors, respectively; and
an arrester configured to transmit current to the ground in response to a voltage equal to or higher than a selected voltage threshold being applied across the arrester.

9. The apparatus of claim 1, further comprising a pre-charge resistor connected in parallel with the first switch.

10. The apparatus of claim 1, wherein the controller is configured to turn on the first switch, the second switch, and the third switch for performing charging through the first AC terminal, the second AC terminal, and the third AC terminal.

11. A method for controlling a charging and discharging apparatus for a vehicle, the method comprises:
transmitting external power to a battery via a charging/discharging port, via an input filter unit, and via a power factor correction circuit,
wherein the charging/discharging port comprises a first AC terminal, a second AC terminal, a third AC terminal, and a neutral terminal,
wherein the power factor correction circuit comprises a plurality of inductors respectively corresponding to the first AC terminal, the second AC terminal, and the third AC terminal, and
wherein the input filter unit comprises a first switch configured to selectively interconnect the first AC terminal and a first corresponding one of the inductors, a second switch configured to selectively interconnect the second AC terminal and a second corresponding one of the inductors, a third switch configured to selectively interconnect the third AC terminal and a third corresponding one of the inductors, and an interleaving switch configured to selectively interconnect the first AC terminal and the second AC terminal; and
sequentially turning off a second switch and a third switch in response to charging through the first AC terminal, the second AC terminal, and the third AC terminal being ended.

12. The method according to claim 11, wherein the sequentially turning off comprises turning off the second switch and then turning off the third switch in response to the first AC terminal and the second AC terminal being selectively interconnected through the interleaving switch.

13. The method of claim 12, wherein the turning off the second switch and then turning off the third switch comprises:
turning on the interleaving switch after turning-off the second switch; and
turning off the third switch after turning-on of the interleaving switch.

14. The method of claim 13, further comprising turning off the interleaving switch after turning-off of the third switch.

15. The method of claim 14, wherein the turning-off of the second switch, the turning-on of the interleaving switch, the turning-off of the third switch, and the turning-off of the interleaving switch are performed at selected time intervals.

16. The method of claim 15, wherein the selected time intervals are set depending on a time taken to turn on each of the second switch, the interleaving switch, and the third switch, or a time taken to turn off each of the second switch, the interleaving switch, and the third switch.

17. The method of claim 11, further comprising turning off the first switch in response to the charging being ended.

18. The method of claim 11, further comprising turning on the first switch, the second switch, and the third switch for performing charging through the first AC terminal, the second AC terminal, and the third AC terminal.
